(19) United States
(12) Patent Application Publication
(10) Pub. No.: US 2012/0292885 A1
(43) Pub. Date: Nov. 22, 2012

(54) COLLAPSIBLE TOW BAR FOR LIGHT AIRCRAFT

(76) Inventor: Paul Michael Matyszyk, Clayton, GA (US)

(21) Appl. No.: 13/112,053

(22) Filed: May 20, 2011

(51) Int. Cl. B60D 1/14

(52) U.S. Cl. 280/503

(57) ABSTRACT

A tow bar adapted to be coupled to a steerable nose wheel assembly of an aircraft. The tow bar includes an arm assembly having a handle at a first end thereof and an oppositely-disposed second end. First and second arms are pivotally coupled at first ends thereof to the arm assembly to enable oppositely-disposed second ends of the first and second arms to pivot toward and away from each other. Engagement members are disposed at the second ends of the first and second arms, and each engagement member is adapted to engage a portion of the steerable nose wheel assembly. A mechanism is provided for locking the first and second arms to prevent their pivoting relative to each other.

### BACKGROUND OF THE INVENTION

The present invention relates to vehicle tow bars, and in particular to tow bars suitable for use with light aircraft equipped with a nose wheel assembly to which a tow bar may be attached.

Light aircraft, and particularly single-engine aircraft, are often manually maneuvered while on the ground. For this purpose, tow bars have been developed that are adapted to engage the nose wheel assembly in some manner, as evidenced by U.S. Pat. Nos. 4,269,429, 4,470,564 and 7,464,974. A tow bar should be sufficiently rigid during use to provide the operator with greater control over the movement of the aircraft. Furthermore, a tow bar should be sufficiently long so that the operator can avoid the blades of the propeller and maneuver an airplane in a comfortable and safe manner while the operator is substantially upright. While various types of tow bars are commercially available, including those capable of use with a variety of different types of aircraft, tow bars that can be stored within an aircraft would be especially convenient to aircraft operators. However, to fit within an aircraft, a tow bar must typically be collapsible to a much smaller size, which includes its overall length.

There is an ongoing need for a collapsible tow bar that is of minimal weight and can be collapsed to a convenient size for storage within a small aircraft, yet is simple to expand and when expanded is sufficiently rigid and long to perform effectively.

### BRIEF DESCRIPTION OF THE INVENTION

The present invention provides a tow bar for maneuvering light aircraft, such as single-engine airplanes having a steerable nose wheel assembly to which a tow bar may be connected.

According to a first aspect of the invention, the tow bar includes an arm assembly having a handle at a first end thereof and an oppositely-disposed second end. First and second arms are pivotally coupled at first ends thereof to the arm assembly so that the first ends of the first and second arms are spaced apart and separated by the arm assembly and oppositely-disposed second ends of the first and second arms are able to pivot toward and away from each other. First and second engagement members are disposed at the second ends of the first and second arms, respectively, and each of the first and second engagement members is adapted to engage a portion of the steerable nose wheel assembly. Means is provided for locking the first and second arms to prevent the first and second arms from pivoting relative to each other. The arm assembly is coupled to the first and second arms to enable the arm assembly to acquire a deployed configuration in which the first end of the arm assembly extends in an opposite direction relative to the first and second arms, and to also acquire a stowable configuration in which the arm assembly is between the first and second arms.

A technical effect of the invention is the ability of the tow bar to be collapsed to a stowable configuration that is sufficiently small and light to enable the tow bar to be conveniently stowed on board a light aircraft, yet can also be easily expanded to a deployed configuration that is sufficiently rigid and long to maneuver the aircraft.

Other aspects and advantages of this invention will be better appreciated from the following detailed description.

### BRIEF DESCRIPTION OF THE DRAWINGS

FIG. 1 is a perspective view of a collapsible tow bar according to a first embodiment of the present invention, with the tow bar shown in a deployed configuration and coupled to a nose wheel strut of an aircraft.

FIG. 2 is a plan view of the tow bar of FIG. 1 after being collapsed to acquire a stowable configuration of the tow bar.

FIG. 3 is a perspective view of the tow bar of FIGS. 1 and 2 in the deployed configuration thereof.

FIG. 4 is a cross-sectional view of the tow bar of FIGS. 1 through 3 along section line 4-4 of FIG. 2.

FIG. 5 is a perspective view of a collapsible tow bar according to a second embodiment of the present invention, with the tow bar shown in a deployed configuration for coupling to a nose wheel strut of an aircraft.

FIG. 6 is a plan view of the tow bar of FIG. 5 after being collapsed to acquire a stowable configuration of the tow bar.

FIG. 7 is a cross-sectional view of the tow bar of FIGS. 5 and 6 along section line 7-7 of FIG. 6.

### DETAILED DESCRIPTION OF THE INVENTION

The present invention comprises a tow bar adapted for manually maneuvering an aircraft on the ground, and in particular light aircraft equipped with a steerable nose wheel assembly, as is often found on single-engine aircraft. Notable but nonlimiting examples of such aircraft include certain models manufactured by the Cessna Aircraft Company.

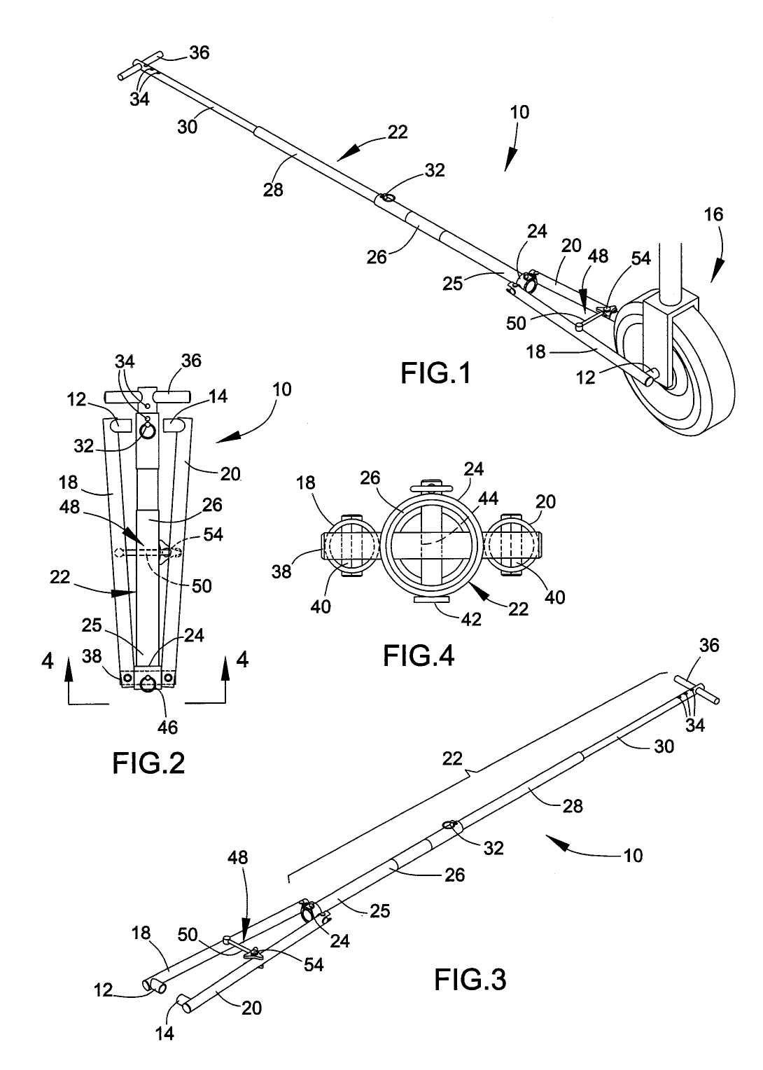

FIGS. 1 through 7 represent two embodiments of collapsible tow bars 10 that can be extended to a deployed configuration (FIGS. 1, 3 and 5) for towing and maneuvering an aircraft, and collapsed to a stowable configuration (FIGS. 2 and 6) that has a sufficiently small profile or outline to be readily stowed within the cabin of a light aircraft.

Referring to FIGS. 1 through 4, the tow bar 10 is represented as comprising engagement members 12 and 14 that oppose each other and are adapted to engage opposite sides of an aircraft steerable nose wheel assembly 16, generally as shown in FIG. 1. For this purpose, the engagement members 12 and 14 are coaxially aligned and their opposing ends are preferably configured to engage the axle or hub of the wheel assembly 16. For example, the engagement members 12 and 14 can be configured as sockets adapted to engage the ends of the wheel axle of the wheel assembly 16 or engage recesses defined in the ends of the wheel axle. The engagement members 12 and 14 are represented as having approximate equal axial lengths. As nonlimiting examples, the members 12 and 14 may have axial lengths of about three centimeters and approximately equal diameters of about two centimeters, though greater and lesser lengths and diameters are also within the scope of the invention. The engagement members 12 and 14 are mounted at distal ends of a corresponding pair of arms 18 and 20, respectively. The members 12 and 14 can be mounted with, for example, screws, roll pins, rivets, welds, etc. The arms 18 and 20 have approximately equal axial lengths, for example, about fifty centimeters, and approximately equal outer dimensions, for example, diameters of about two centimeters, though again greater and lesser dimensions are also within the scope of the invention. The engagement members 12 and 14 and arms 18 and 20 are represented as having cylindrical outer shapes, though other cross-sectional shapes are possible, depending on the type of material used in their construction. In addition, the engagement members 12 and 14 and/or arms 18 and 20 may have tubular constructions, in other words, hollow along their entire lengths. According to a particular embodiment of the invention, the engagement members 12 and 14 and arms 18 and 20 are formed of an aluminum alloy, such as Al 6061.

The arms 18 and 20 are pivotally attached to an extension arm assembly 22, for example, with an annular-shaped coupling 24 mounted on a distal end 25 of the arm assembly 22. The arms 18 and 20 is represented as pivotally connected to the coupling 24 with a pin or shaft 38 that extends through the coupling 24, through the end 25 of the arm assembly 22, and through the end of each arm 18 and 20. As represented in more detail in FIG. 4, the shaft 38 is secured within the arms 18 and 20 with roll pins 40, which allow the arms 18 and 20 to pivot toward and away from each other and, therefore, enables the distance between the engagement members 12 and 14 to be adjusted to allow the members 12 and 14 to engage and disengage the wheel assembly 16. In addition, a cross pin 42 passes through the coupling 24, through the end 25 of the arm assembly 22, and through a diametrical hole 44 in the shaft 38 to releasably secure the shaft 38 to the arm assembly 22 and its coupling 24. As represented in FIG. 2, the pin 42 can be secured with a split ring 46 that, when removed, allows the pin 42 to be withdrawn from the hole 44 in the shaft 38. By removing or at least sufficiently retracting the cross pin 42 to disengage the shaft hole 44, the arms 18 and 20 and shaft 38 are permitted to rotate relative to the arm assembly 22 about the axis of the shaft 38, which is transverse and preferably perpendicular to the axis of the arm assembly 22. In this manner, the arm assembly 22 and the arms 18 and 20 are able to be rotated relative to each other, and between the deployed configuration shown in FIGS. 1 and 3 and the stowable configuration shown in FIG. 2. As evident from FIGS. 1 and 3, the arm assembly 22 extends away from the arms 18 and 20 in the deployed configuration, terminating with a handle 36 that is located at an opposite end of the tow bar 10 relative to the engagement members 12 and 14. The handle 36 is shown as being configured as a T-handle, though other configurations are possible. As evident from FIG. 2, in the stowable configuration the arm assembly 22 is between the arms 18 and 20 and the handle 36 is adjacent the engagement members 12 and 14, while the end 25 of the arm assembly 22 remains disposed between the ends of the arms 18 and 20 to which it is pivotally coupled with the shaft 38. Notably, all but the handle 36 of the arm assembly 22 is disposed between the arms 18 and 20, resulting in a very compact stowable configuration.

The arm assembly 22 shown in FIGS. 1 through 3 is represented as further comprising three extension arm sections 26, 28, and 30 that are telescopically assembled together. While three arm sections 26, 28 and 30 are shown, two arm sections or more than three arm sections could be employed. The arm section 28 is larger in diameter than the arm section 30 to accommodate the latter, and the arm section 26 is largest in diameter to accommodate both of the remaining arm sections 28 and 30. Consequently, at least the arm sections 26 and 28 have a tubular shape. For purposes of maximizing the strength-to-weight ratio of the tow bar 10, the arm sections 26, 28 and 30 preferably have a tubular construction. Al 6061 is again a suitable material for the arm sections 26, 28 and 30. The arm sections 26, 28, and 30 can be equipped with any suitable features, for example, pins, screws, rivets or flanges that permit the arm assembly 22 to expand to its fully deployed configuration (shown in FIGS. 1 and 3), while preventing the smaller arm sections 28 and 30 from being completely removed from their larger adjacent arm sections 26 and 28, respectively. As represented in FIG. 2, to prevent unintended extension of the arm assembly 22, the arm sections 26 and 30 can be secured to each other in their collapsed positions with a pin 32 that is mounted to the arm section 26 and adapted to engage one or more holes 34 provided in the arm section 30. As evident from FIGS. 1 and 3, the pin 32 can also be used to secure the arm sections 26 and 28 together in their extended positions, for example, by passing through a complementary hole (not shown) in the arm section 28.

A locking mechanism 48 is attached to the arms 18 and 20 to allow for adjusting and fixing the distance between the arms 18 and 20 and their respective engagement members 12 and 14. The locking mechanism 48 is represented as being a friction lock assembly comprising a bar 50 attached to the arm 18, a collar (not shown) mounted to the arm 20 and in which the bar 50 is slidably received, and a knob 54 that is threaded into the collar in order to selectively engage and disengage the bar 50 within the collar in order to lock and release, respectively, the bar 50 relative to the collar and, therefore, the arms 18 and 20 relative to each other. Other locking assemblies are possible and within the scope of the invention.

In view of the above, the tow bar 10 can be converted from the stowable configuration of FIG. 2, in which the arm assembly 22 is between the arms 18 and 20, to the deployed configuration of FIGS. 1 and 3, in which the arm assembly 22 is not between the arms 18 and 20 and instead extends away from the arms 18 and 20, by disengaging the pin 42 from the shaft 38 to allow the arms 18 and 20 to rotate relative to the arm assembly 22. As evident from FIG. 4, rotating the arms 18 and 20 about 180 degrees relative to the arm assembly 22 enables the pin 42 to re-engage the diametrical hole 44 in the shaft 38 and lock the positions of the arms 18 and 20 in the deployed configuration. In addition, the arm assembly 22 is telescopically extended by disengaging the pin 32 located on the arm section 26 from the holes 34 located in the arm section 30, and then engaging the pin 32 in a hole (not shown) located in the arm section 28 to lock the arm sections 26 and 28 in the deployed (extended) configuration. The engagement members 12 and 14 can then be coupled to the axle of the steerable nose wheel assembly 16 (FIG. 1) by loosening the locking mechanism 48 to allow the arms 18 and 20 and their engagement members 12 and 14 to pivot toward each other and into engagement with the axle, after which the locking mechanism 48 can be tightened to lock the engagement members 12 and 14 in engagement with axle. An operator can then grasp the handle 36 to maneuver the aircraft by pushing, pulling and moving the tow bar 10 laterally from side to side.

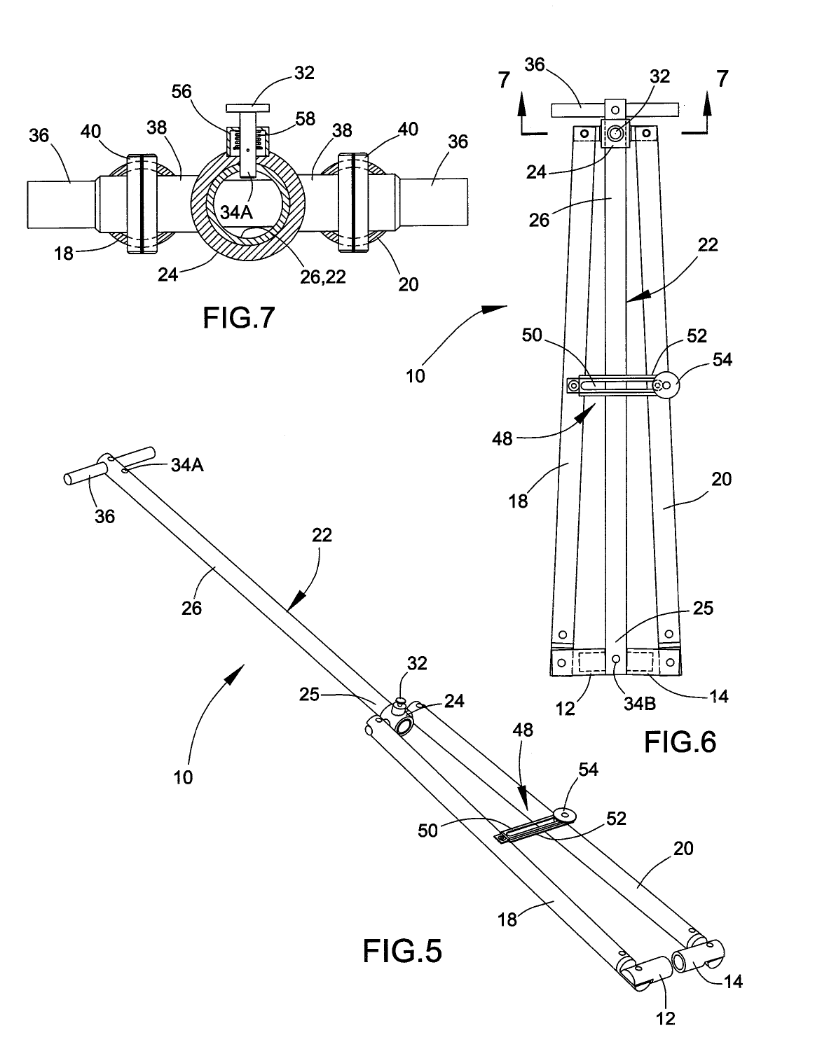

The embodiment of FIGS. 5 through 7 is similar in may respects to the embodiment of FIG. 1 through 4, and therefore the same reference numbers will be used in FIGS. 5 through 7 to designate components that are the same or functionally equivalent to components identified above for the embodiment of FIGS. 1 through 4.

In one respect, the embodiment of FIGS. 5 through 7 differs as a result of the arm assembly 22 comprising, in addition to the handle 36, a single arm section 26, which is slidably received in the collar 24 secured between the arms 18 and 20. Instead of telescoping, the entire arm assembly 22 is able to slide through the collar 24 until its end 25 opposite the handle 36 is disposed between the engagement members 12 and 14, the handle 36 is adjacent the collar 24, and the arm assembly 22 is between the arms 18 and 20, resulting in the stowable configuration of FIG. 6.

In another respect, the embodiment of FIGS. 5 through 7 differs as a result of the pin 32 being biased with a spring 58 disposed within a collar 56 with which the pin 32 is mounted to the collar 24 of the arm section 26. The spring 58 biases the pin 32 into engagement with either of two holes 34A (FIG. 5) and 34B (FIG. 6) at opposite ends of the arm section 26. The spring 58 permits the pin 32 to be sufficiently retracted to disengage the hole 34A or 34B with which it is engaged. In the deployed configuration of FIG. 5, the pin 32 is engaged with the hole 34B, and by disengaging the pin 32 from the hole 34B the arm assembly 22 is allowed to be retracted through the collar 24 until the pin 32 is able to engage the hole 34A near the handle 36 of the arm assembly 22, at which time the arm assembly 22 can be locked in its stowable configuration shown in FIG. 6. Notably, similar to the embodiment of FIGS. 1 through 4, all but the handle 36 of the arm assembly 22 is disposed between the arms 18 and 20, resulting in a very compact stowable configuration.

Another difference embodied in FIGS. 5 through 7 is that the shaft 38 of FIGS. 1 through 4 is replaced with pins or trunnions 38 projecting in opposite directions from the collar 24. As represented in more detail in FIG. 7, the arms 18 and 20 are pivotally connected to the trunnions 38 with roll pins 40 or any other suitable fastener. The roll pins 40 allow the arms 18 and 20 to pivot toward and away from each other, similar to the arms 18 and 20 of the embodiment of FIGS. 1 through 4. Relative movement of the arms 18 and 20 is again restricted with a locking mechanism 48, represented in FIGS. 5 and 6 as being a friction lock assembly comprising a bar 50 attached to the arm 18 and slidably received in a channel 52 attached to the arm 20, and a thumb screw or knob 54 that is threaded into the bar 50 for selective frictionally engagement with the channel 52 when sufficiently threaded into the bar 50. Other locking assemblies are possible and within the scope of the invention.

In view of the above, it can be appreciated that both embodiments of the invention provide a compact design that allows for convenient storage onboard a light aircraft, while also providing a sufficiently long and rigid tow bar 10 that can be readily deployed for use and the collapsed for stowing. The components of the tow bars 10 can be fabricated using various techniques and materials, such as wrought 6061 aluminum alloy or another relatively light and corrosion-resistant material.

While the invention has been described in terms of particular embodiments, it is apparent that other forms could be adopted by one skilled in the art. In addition, components and features of either embodiment can be utilized in the other embodiment. For example, the pins 32 and 42 of the embodiment shown in FIGS. 1 through 4 could be spring-biased similar to the pin 32 of the embodiment shown in FIGS. 5 through 7, and the arm assembly 22 of the embodiment shown in FIGS. 5 through 7 could comprise two or more telescoping arm sections similar to the arm sections 26, 28 and/or 30 of FIGS. 1 through 4. Accordingly, the scope of our invention is to be limited only by the following claims.

1. A tow bar adapted to couple to a steerable nose wheel assembly of an aircraft, the tow bar comprising:
an arm assembly having a handle at a first end thereof and an oppositely-disposed second end;
first and second arms pivotally coupled at first ends thereof to the arm assembly so that the first ends of the first and second arms are spaced apart and separated by the arm assembly and to enable oppositely-disposed second ends of the first and second arms to pivot toward and away from each other;
first and second engagement members disposed at the second ends of the first and second arms, respectively, each of the first and second engagement members being adapted to engage a portion of the steerable nose wheel assembly;
means for locking the first and second arms to prevent the first and second arms from pivoting relative to each other;
wherein the arm assembly is coupled to the first and second arms to enable the arm assembly to acquire a deployed configuration in which the first end of the arm assembly extends in an opposite direction relative to the first and second arms and to also acquire a stowable configuration in which the arm assembly is between the first and second arms.

2. The tow bar according to claim 1, wherein the arm assembly is pivotably coupled to the first and second arms so that the arm assembly can be pivoted between the deployed configuration in which the first end of the arm assembly extends in an opposite direction relative to the first and second arms and the second end of the arm assembly is between the first ends of the first and second arms, and the stowable configuration in which the arm assembly is between the first and second arms, the handle is adjacent the engagement members, and the second end of the arm assembly is disposed between the first ends of the first and second arms.

3. The tow bar according to claim 2, wherein the arm assembly is pivotally coupled to the first and second arms with a shaft, and the tow bar further comprises a pin adapted to engage the shaft to selectively lock the arm assembly in the deployed configuration and in the stowable configuration.

4. The tow bar according to claim 3, wherein the pin is biased with a spring to engage the shaft.

5. The tow bar according to claim 2, wherein the arm assembly comprises at least two telescoping arm sections, the arm assembly is telescopically extended in the deployed configuration, and the arm assembly is telescopically retracted in the stowable configuration.

6. The tow bar according to claim 5, the tow bar further comprising a pin adapted to engage the telescoping arm sections to selectively lock the arm assembly in the deployed configuration and in the stowable configuration.

7. The tow bar according to claim 6, wherein the pin is biased with a spring to engage the telescoping arm sections.

8. The tow bar according to claim 1, wherein the arm assembly is slidably coupled to the first and second arms so that the arm assembly can be slid between the deployed configuration in which the first end of the arm assembly extends in an opposite direction relative to the first and second arms and the second end of the arm assembly is between the first ends of the first and second arms, and the stowable configuration in which the arm assembly is between the first and second arms, the handle is adjacent the first ends of the first and second arms, and the second end of the arm assembly is disposed between the engagement members.

9. The tow bar according to claim 8, wherein the arm assembly is slidably coupled to the first and second arms with a collar coupled to the first ends of the first and second arms and through which the arm assembly slides.

10. The tow bar according to claim 9, the tow bar further comprises a pin adapted to engage holes in the arm assembly to selectively lock the arm assembly in the deployed configuration and in the stowable configuration.

11. The tow bar according to claim 10, wherein the pin is biased with a spring to engage the arm assembly.
